(19) United States
(12) Patent Application Publication
(10) Pub. No.: US 2012/0072994 A1
(43) Pub. Date: Mar. 22, 2012

(54) METHOD TO PRODUCE SECURING DATA, CORRESPONDING DEVICE AND COMPUTER PROGRAM

(75) Inventor: Pascal Urien, Villepreux (FR)

(73) Assignee: INSTITUT TELECOM / TELECOM PARISTECH, Paris Cedex 13 (FR)

(21) Appl. No.: 13/257,221

(22) PCT Filed: Mar. 16, 2010
(86) PCT No.: PCT/EP10/53334

§ 371 Date: Nov. 28, 2011

(30) Foreign Application Priority Data
Mar. 16, 2009 (FR) 09/51646

(51) Int. Cl. G06F 21/00

(52) U.S. Cl. 726/26

(57) ABSTRACT

A method and apparatus are provided for generating security data for implementing a secure session between a first and at least a second entity according to a secure session establishment protocol. Such a method includes: initializing a third secure entity connected to the first entity; generating at least a portion of the security data within the third entity; transmitting the generated security data from the secure third entity to the first entity; and transmitting at least a portion of the security data generated in the third secure entity to at least a previously initialized fourth secure entity connected to the third secure entity.

### CROSS-REFERENCE TO RELATED APPLICATIONS

This Application is a Section 371 National Stage Application of International Application No. PCT/EP2010/053334, filed Mar. 16, 2010 and published as WO 2010/106042 on Sep. 23, 2010, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure pertains to the field of the management of information exchanges made between two entities of a communications network.

More particularly, the present disclosure relies on the securing of such exchanges. Many applications, especially commercial applications or applications for access to confidential information use SSL (Secure Socket Layer) or TLS (Transport Layer Security) protocols to exchange data in a secured manner. Although mathematical proofs exist for these protocols, the fact that they are integrally executed by unreliable computer systems can enable attacks which diminish the confidence that must legitimately be provided to exchange procedures implementing these protocols.

### BACKGROUND OF THE DISCLOSURE

The implementation of a secured connection between two entities of a communications network requires the initiation of a secured session based either on the SSL protocol or on the TLS protocol.

Thus, to set up such a session, the two entities use mechanisms which are supposed to ensure that the session created will not be subjected to piracy or snooping. Now, the entities in question are often vulnerable and non-secured so that even if they produce security-providing data (for example certificates, cryptography keys or shared secrets) in compliance with the security protocols (SSL or TLS for example), there is nothing to ensure that these entities have not preliminarily been subjected to an attack and that the securing data are not being retrieved directly while they are being computed.

The published patent application WO 2008/145558 describes a method for securing exchanges in which securing data is produced to implement a secured session between a first entity and a second entity according to a protocol for setting up secured sessions such as an SSL or TLS protocol. This method partly resolves the drawbacks entailed by the implementation of the SSL and TLS protocols by non-secured entities.

This method includes an initialization of a third-party secured entity, linked to a first entity, the generation of a part of the securing data within the third entity and a transmission of securing data from the third securing entity to said first entity. Typically, the third entity is for example a JavaCard type of smart card which performs a part of the computations needed to set up the secured session.

Thus, the method described in WO 2008/145558 enables the initiation of a data exchange between two entities while at the same time ensuring that the cryptography material needed to set up the session has been designed in a secured manner.

However, when several exchanges of different files are obligatory, it becomes necessary to resort to the method described in WO 2008/145558 as many times as there are files to be exchanged. Now, the processing and input/output capacities of the secured entities such as the smart cards or Java cards are often low; it is not realistic in terms of performance to use a securing entity of this kind to carry out intensive cryptography treatment operations. Thus, the method described in WO 2008/145558 cannot be used alone when high performance is required and when many secured sessions have to run in parallel.

### SUMMARY

An embodiment of the invention does not have these drawbacks of the prior art.

An embodiment of the invention pertains to a method for producing securing data for implementing a secured session between a first entity and at least one second entity, according to a protocol for setting up secured sessions.

According to an embodiment of the invention, such a method comprises:
a step for initializing a third secured entity linked to said first entity;
a step for generating at least one part of said securing data within said third entity;
a first step for transmitting said securing data generated by said third secured entity towards said first entity;
a second step for transmitting at least one part of said securing data generated within said third secured entity intended for at least one fourth secured entity preliminarily initialized and linked to said third secured entity.

Thus, an embodiment of the invention enables different secured entities such as for example chips, smart cards, dongles etc to have available securing data, such as encipherment data while at the same time not needing to generate these pieces of data themselves. These pieces of data are generated by means of another secured entity and transmitted after their creation to be subsequently reused.

According to one particular embodiment of the invention, said third entity, called a master entity, generates at least one part of a secret shared between said first and said second entity.

Thus, the secret is shared equally with all the secured entities. They can therefore re-utilize the secret thereafter for example to start a new secured session if need be.

More particularly, said at least one part of said generated securing data transmitted to said at least one fourth entity, called a slave entity, includes said shared secret in an enciphered form and at least one secured communications session identifier.

Thus, the fact of transmitting the securing data in enciphered form to the slave module makes it possible to prevent any theft or attempted theft of these pieces of securing data.

According to one particular embodiment of the invention, said secured session set-up protocol is the SSL protocol.

According to one particular embodiment of the invention, said secured session set-up protocol is the TLS protocol.

According to one particular characteristic of an embodiment of the invention, said method for producing furthermore comprises:
a step for the transmission, by said first entity, of at least one message to a functional “RECORD” unit implemented within said third entity;
a step of reception, by said first entity, of at least one message coming from said functional “RECORD” unit;
a step for the computing of a set of keys by said third entity;
a step for the collecting of said set of available keys by said first entity from said third entity.

Thus, an embodiment of the invention is capable of generating secrets shared by several secured entities such as for example several smart cards, because all the keys are computed by the third entity.

More particularly, said second step of transmission is implemented by a manager of security modules which obtains said securing data from said third entity.

According to one particular characteristic of an embodiment of the invention, said second transmission step is implemented during a phase for resuming said secured session.

Thus, an embodiment of the invention enables the centralized management of the sharing of keys between the secured entities and thus increases the level of security of the entire system.

According to another aspect, an embodiment of the invention also pertains to a method for setting up a secured communications session between a first and at least one second entity, according to a protocol for setting up a secured session. According to an embodiment of the invention, such a method comprises:
a step for obtaining a session identifier and an ephemeral secret computed during a previous communications session secured by a third secured entity linked to said first entity;
a step for transmitting said session identifier and said ephemeral secret to a fourth secured entity preliminarily initialized and linked to said third secured entity;
a step for setting up said secured communication session by using said fourth secured entity.

Thus, an embodiment of the invention enables the use of other secured entities such as smart cards or Javacards to set up secured communications sessions which have been previously initialized by another secured entity. Consequently, an embodiment of the invention enables the parallel processing of several transactions such as for example the downloading of files, by using services of several secured entities while minimizing session set-up times to set up a session and at the same time offering an excellent level of security.

An embodiment of the invention also pertains to a device for producing securing data, enabling the implementation of a secured session between a first entity and at least one second entity, according to a protocol for setting up secured sessions. According to an embodiment of the invention, such a device comprises:
means for initializing a third secured entity attached to said first entity;
means for generating at least one part of said securing data within said third entity;
means for transmitting said securing data to said first entity;
means for transmitting at least one part of said securing data generated within said third secured entity intended for at least one fourth secured entity preliminarily initialized and linked to said third secured entity.

According to one particular embodiment of the invention, said generating means and said transmitting means are grouped together in a smart card.

According to one particular embodiment, the invention also pertains to a portable device, such as an USB key comprising means for storing a manager of security modules and at least two SIM-format card readers and a device for producing securing data as described here above.

According to another aspect, an embodiment of the invention pertains to a software product downloadable from a communications network and/or stored on a computer-readable carrier and/or executable by a microprocessor, and comprising program code instructions for executing the method for producing as described here above.

According to another aspect, an embodiment of the invention also pertains to a software product downloadable from a communications network and/or stored on a computer-readable carrier and/or executable by a microprocessor, and comprising program code instructions for executing the method for setting up a session as described here above.

### BRIEF DESCRIPTION OF THE DRAWINGS

Other features and advantages shall appear more clearly from the following description of a preferred embodiment, given by way of a simple, illustratory and non-exhaustive example, and from the appended drawings, of which:

FIG. 1 is a block diagram of the method for producing secured data according to an embodiment of the invention;

FIG. 2 illustrates an example of implementation of the securing method by means of a grid of security modules according to an embodiment of the invention;

FIG. 3 presents the logic architecture of a grid of security modules according to an embodiment of the invention;

FIG. 4 describes an architecture of a device for producing securing data, also called a security module.

### DETAILED DESCRIPTION OF ILLUSTRATIVE EMBODIMENTS

### 1. Reminder of the Principle of An Embodiment of the Invention

The general principle of an embodiment of the invention relies on a joint implementation of a set including several security modules and known as a grid of security modules. This grid of security modules includes several secured entities which come in to act in the setting up of the secured communication session. Thus, unlike in the case of the method described in the document WO 2008/145558, an embodiment of the invention can be used to resolve the problems of performance inherent in the use of external secured entities.

Thus, an embodiment of the invention raises the level of security when setting up the secured session while at the same time maintaining the general performance of the authentication system constituted by entities wishing to set up a secured session (for example a client and a server) and of the grid of security modules (including the third and fourth entities) which is for example linked to the client.

As a rule, the grid of security modules can take the form of one or more “dongle” type smart cards to be inserted into a specific card reader to be inserted for example into a USB (Universal Serial Bus) type of location of a computer or any other form enabling communications between the entity wishing to set up a secured session and the grid of security modules.

The grid of security modules can be dedicated to implementing a particular protocol such as the SSL and/or the TLS. However, it is not the only possible embodiment of the invention. It is indeed possible to envisage a situation where the grid of security modules can implement several protocols in order to ensure greater interoperability.

It is recalled that the term “security module”, in the context of the invention, designates an electronic chip usually called a “Tamper Resistant Device” which is capable of managing physical and logic countermeasures.

This security module comprises especially an SSL/TLS software stack comprising HANDSHAKE, ALERT, CCS and RECORD functional units which are well known to those skilled in the art. This security module communicates with a user entity (client or server) by means of a functional interface used to exchange SSL/TLS protocol messages and obtain at least four types of parameters: “keys_bloc”, “cipher_suite”, “SessionID” and the enciphered value of “master_secret”.

The enciphered value of “master-secret” (Master_secret*) is obtained by means of a secret key shared between the different security modules and a public value salt according to the relationship,

Master_secret*=F(Key_Module, salt, MasterSecret)

The entity using the security module manages a communications layer and integrates the functional units ALERT and RECORD and optionally the functional units HANDSHAKE and CCS. The pieces of information coming from the APPLICATION layer are secured by the RECORD layer.

An embodiment of the invention proposes the joint implementing of the user entity and of the grid of security modules to set up a secured session with a server. Ingeniously, a part of the steps needed to set up the session is performed by means of the grid of security modules while the other part is done by the user entity. It can be the case, in one particular embodiment of the invention, that the steps implemented by the user entity and by the grid of security modules differ at each creation of a new secured session. Thus, it is more difficult to plan for the general functioning of the system and try to force the securing mechanism offered by an embodiment of the invention.

In one particular embodiment of the invention, within the grid of security modules, there is a distinction between two different types of security modules: the master modules and the slave modules. A slave security module depends on a master security module without which it cannot work. More particularly, according to an embodiment of the invention, a master module is the only unit capable of computing a particular ephemeral secret (the “mastersecret”, which is the term that shall be used here below).

It may be recalled that the “mastersecret” in the context for example of the implementation of the TLS protocol is computed during the phase known as the “full mode” phase. During this phase, the exchanges between the client and the server enable the computation of a common secret, shared between the client and the server, and serving as the basis for the creation of all the other encipherment data needed for the secured session.

In a grid of security modules according to an embodiment of the invention, only one master module can participate with the user entity in computing this “mastersecret”.

Here below, in order to provide for a faster session-resuming mechanism, for example in the context of a phase known as the “resumed mode” phase, a slave module can use the “mastersecret” computed by its master module to continue a secured session or to perform other operations during the secured session.

According to an embodiment of the invention, a slave module comes into possession of the “mastersecret” by means of the master module with which it is associated. To this end, the master module distributes this “mastersecret” according to an embodiment of the invention to the slave modules but in a secured manner.

This means that, according to an embodiment of the invention, the distribution of the “mastersecret” is done according to a particular protocol governing the data exchanges between the master module and the slave module with which it is associated. Such a protocol can take the form of commands which are transmitted to these modules to enable the exchange.

Again according to an embodiment of the invention, from a logic viewpoint, the identity of the user entity is linked solely to the master module. This means that in the process of setting up the secured session, the user entity does not know of the presence of the slave modules.

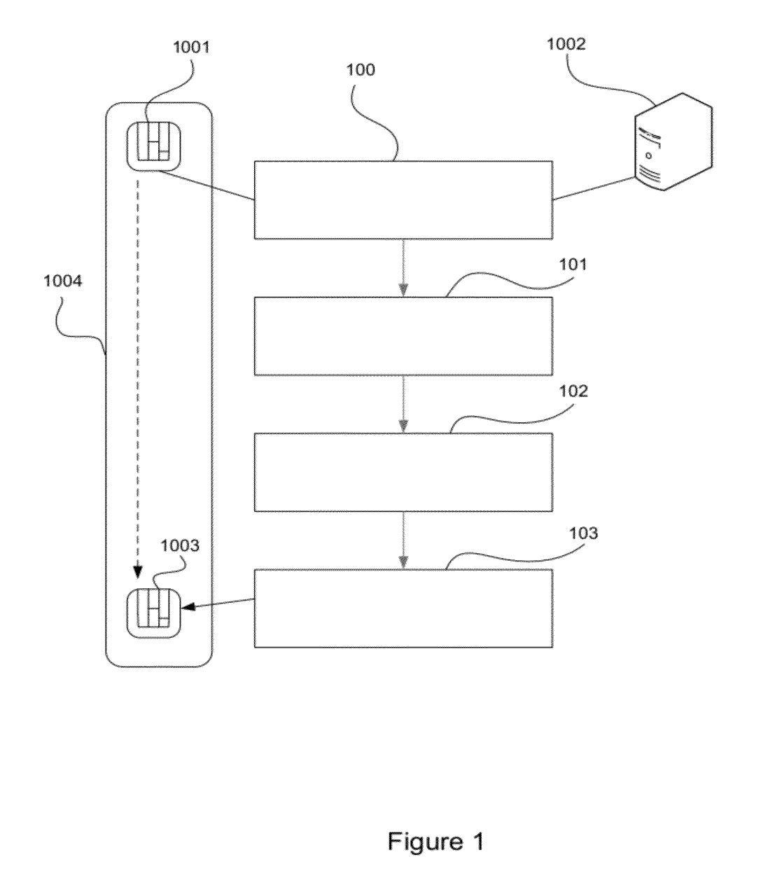

Referring to FIG. 1, we present the method for producing secured data according to an embodiment of the invention. This method comprises:
a step (100) for initializing a security module 1001 (for example a smart card) attached to a first entity 1002 (for example a personal computer);
a step (101) for generating a part of the security data within the security module;
a step (102) for transmitting securing data from the security module to the first entity;
a step (103) for transmitting at least one part of said securing data generated within the security module 1001 to a second security module 1003 preliminarily initialized and linked to the first secured module 1001, thus forming a grid of security modules 1004 in which at least certain pieces of securing data are shared.

In other words, an embodiment of the invention proposes a grid of security modules used to set up secured data transmission sessions and sharing data to set up these secured transmission sessions.

Here below, we present an embodiment of the invention in which a security module manager, integrated into the grid of security modules, manages the general operation of this grid. It is clear however that the invention is not limited to this particular mode of implementation.

### 2. Description of An Embodiment

In this embodiment, we present the implementation of a grid of security modules according to the invention.

A description is given of the original functions of a grid of security modules which, according to an embodiment of the invention, carries out the authentication phase of the TLS protocol and then enables an application to use the pre-established secured tunnel.

As already mentioned, a security module performs the functions of TLS client and server. Its embedded software program comprises the functional units HANDSHAKE, ALERT, CCS and RECORD.

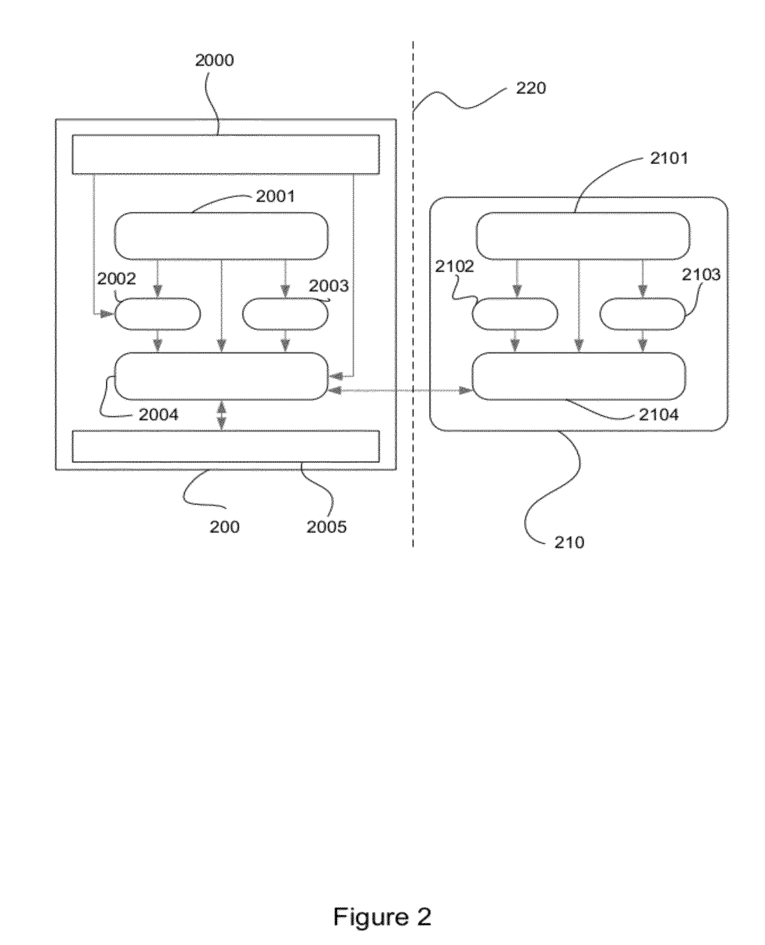

FIG. 2 presents the TLS security module and its user, i.e. an application provided with a subset of the TLS stack, i.e. obligatorily the layers RECORD and ALERT and optionally the layers CCS and HANDSHAKE. This user entity can be a client (for example a client application of a web browser type) or a server (for example a web server managing the secured sessions).

A security module offers a functional interface comprising nine commands, SET-Credentials, Start, Process-TLS, GET-Keys_bloc, Compute-Keys_bloc, GET-Cipher_suite, GET-SessionID, GET-Master_secret, SET-Master-Secret.

Such commands can be make according to the ISO 7816 standard according to an encoding commonly called APDU (Application Protocol Data Unit).

The security module (210) which implements the method of producing according to an embodiment of the invention comprises the functional units needed to implement the securing method, namely the RECORD (2104) and ALERT (2102) layers and optionally the CCS (2103) and HANDSHAKE (2101) layers.

The functional interface (220) enables the user entity (200) to use the security module (210) to produce securing data.

### 3. Description of the Commands

3.1 SET-Credentials Command

The role of the module, i.e. its client or server entity behavior as well as the different parameters needed for its operation, usually called letters of credit or credentials (X509 certificates, RSA private key) is activated by the SET-Credentials command ( ):

SET-Credentials(Credentials,role)

3.2 Start(Unix-Time)

In this embodiment, a “Start” command initializes a TLS station; since the security modules do not generally include any clock, they also provide information on GMT time in the format known as UNIX, i.e. a 32-bit number which measures the number of seconds that have elapsed since Jan. 1, 1970:

Start(Unix-Time)

Such a command makes it possible in a manner of speaking to prepare the security module to perform the computations needed in the context of an embodiment of the invention.

3.3 TLS Process

The TLS packets, i.e. the messages produced by a functional unit RECORD are transmitted to the security module by means of the Process-TLS(Record-Packets) command which returns one or more RECORD messages.

Record-Packets=Process-TLS(Record-Packets)

3.4 GET-Keys_bloc

When a TLS security module has successfully conducted the authentication of its interlocutor, it computes the keys_bloc, the layer RECORD shifts into enciphered mode and delivers the CCS and FINISHED messages. The GET-Keys_bloc command then collects all the available keys,

keys_bloc=GET-Keys_bloc( )

The user of the security module services can then autonomously (without the help of the security module) manage its own RECORD layer. Indeed, it knows the keys of the secured channel (keys_bloc) and the current value of the parameters seq_num equal to 1 (the value 0 was used for the integrity computation HMAC of the message FINISHED).

3.5 Compute-Keys_bloc

The Compute-Keys_bloc( )command associated with the random numbers generated by the client entity and the server entity (Client-Random and Server-Random) is used to compute the keys_bloc parameter. It is useful during “Session Resumption” type of session where the user of the security module uses this session only to obtain the keys_bloc.

keys_bloc=Compute-Keys_bloc(Client-Random, Server-Random)

It is important to note that in this case the security module will not export the value of the “master_secret”. It is therefore impossible to conduct a “Session Resumption” type of session when there is no security module which therefore guarantees the user's good faith.

3.6 GET-Cipher_suite

A GET-Cipher_suite command makes it possible to know the security parameters indexed by the number cipher_suite associated with the functional unit RECORD.

cipher_suite=Get-Cipher_suite( )

3.7 GET-SessionID

The GET-SessionID command returns the “SessionID” parameter associated with the previous session associated with a particular “mastersecret”. This is a useful piece of information for the grid of security modules that enables slave modules to perform a “Session Resumption” phase.

SessionID=GET-SessionID( )

3.8 GET-Master Secret

The GET-Master_secret( )command collects an enciphered value of the master_secret(master_secret*) as well as a set of parameters (salt) to carry out the deciphering of this information.

master_secret*|salt=GET-Master_secret( )

The master_secret is enciphered by means of a symmetrical or asymmetrical (Key_Module) secret key, shared by a set of security modules and associated with an enciphering algorithm (such as AES, Triple DES, RSA) and a random number salt generated by the security module.

Master_secret*=F(Key_Module,salt, MasterSecret)

3.9 Set-Master Secret

The Set-Master_Secret(Master_Secret*|Salt, SessionID) command updates a master_secret associated with a SessionID index in a slave type security module for example.

An embodiment of the invention also pertains to any smart card or secured entity of this type comprising the previous commands for the reading, transfer and initialization of a secured session from an ephemeral secret (the “mastersecret”) computed by another secured entity.

In other words, an embodiment of the invention also pertains to a method for setting up a communications session by means of a secured entity which retrieves the ephemeral secret and the identifier of a session that has been previously initialized by another secured entity. These two secured entities are preferably linked to each other so that they are either present within a same smart card or communicate by means of a specific module which will manage the interactions (for example the execution of certain of the previously described commands) between the secured entities.

Thus, the data securing goals are achieved, according to an embodiment of the invention, by means of a management module also called a security module manager of the type hosting and executing a software program fulfilling especially the functions of management and storage of securing data, said software program comprising means to execute retrieval, storage and transmission commands, for example sent to the software by at least one software client and belonging to a predetermined set of retrieval, storage and transmission commands (GET-Session_ID, GET-Master_Secret, Set-Master_Secret, etc.).

### 4. Implementing the Protocol

Using the nine commands described here above, it is possible to implement the grid of security modules.

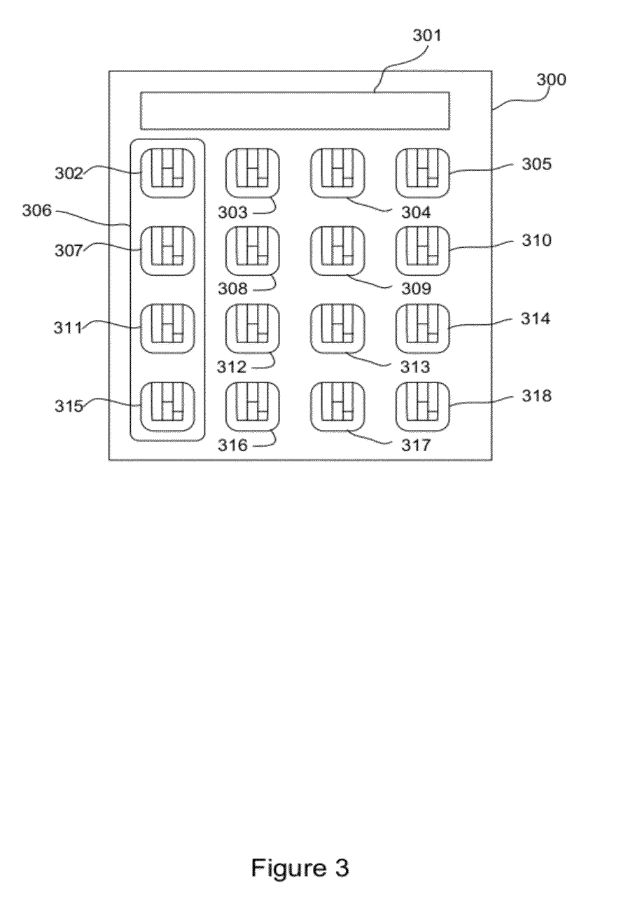

FIG. 3 presents the logic architecture of a grid of security modules according to an embodiment of the invention, a functional unit called the Security Module Manager controls a plurality of security modules.

According to an embodiment of the invention, there are two classes of security modules, modules known as master modules and modules known as slave modules.

The master modules are identified by indices varying from 1 to p. The slave modules are identified by indices strictly greater than p.

A master module stores an X509 certificate but also the RSA private key needed to authenticate the client. The master modules share a key known as KeyModule key used for operations of enciphering and deciphering the mastersecret.

A slave module shares a common cryptographic key KeyModule with the master modules but does not store the client's private key.

The Security Module Manager is associated with at least one master module. The configurations with n modules therefore comprise p master modules (p being greater than or equal to 1) and k=n−p slave modules (k possibly being equal to zero). For example, a grid configuration comprising n=16 modules, including p=4 master modules, will comprise k=12 slave modules.

When a TCP session is opened, the Security Module Manager selects a master security module as a matter of priority. If this operation is impossible, i.e. if all the master modules are assigned to sessions being opened, a slave module is chosen. If no module is free, then the Security Module Manager goes into a state of waiting for a module to become available.

According to an embodiment of the invention, at the start of each session, the Security Module Manager updates the parameters (SessionID, MasterSecret) used by a previous session in using, according to an embodiment of the invention, the Set-MasterSecret command. Through this procedure, it enables a module (master or slave) to manage a session in Resumption mode.

If a slave module fails in its attempts to open a session in Resumption mode by means of the data transmitted by the security module manager, i.e. if the server dictates a session in full mode (for example because the lifetime of the resumed session has expired), it terminates the current session.

At the end of each opening of a session (when the HANDSHAKE procedure is terminated), the Security Module Manager collects the SessionID and MasterSecret parameters) by means of the Get-SessionID and Get-MasterSecret commands introduced by an embodiment of the invention. Thus, the Security Module Manager is capable, during a subsequent session, of providing the collected data both to the master modules and to the slave modules.

Referring to FIG. 3, we present a schematic view of a grid of security modules according to an embodiment of the invention. This grid of security modules 300 includes a component hosting a security module manager (GMS) 301, responsible on the one hand for storing and on the other hand for distributing the data generated by the master modules.

The grid of security modules 300 also has master modules 302 to 305 which generate at least a part of the securing data related to the entity to which the grid of security modules is connected. In the embodiments of the invention presented here above, the master modules compute the value of the MasterSecret for a session in “Full” mode. The grid also comprises slave security modules 307 to 318.

The master modules can be associated with a predetermined number of slave modules (for example three in the example of FIG. 3) thus forming a group of security modules 306. This pre-association is not obligatory. The security module manager 301 can, as needed, dynamically associate the slave security modules according to the required number of securing sessions by means of a functional unit comprising means for obtaining a number of connections or a number of elements to be downloaded if it is for example an http communications session requiring the downloading of images or other elements coming from a Web server.

Such a setting up of secured sessions by means of the method and architecture of the grid of security modules of an embodiment of the invention has numerous advantages.

Let TF and TR respectively denote the time needed to carry out a FULL session and a RESUMPTION session in a security module. For theoretical reasons referred to in many scientific publications, TR is smaller than TF (TR<TF), for example TR is about half of TF. This property is described in detail in the article by Pascal Urien and Mesmin Dandjinou, “The OpenEapSmartcard Platform”, in “Network Control and Engineering for QoS, Security and Mobility, IV: Fourth IFIP International Conference on Network Control and Engineering for QoS, Security, and Mobility, Lannion, France, Nov. 14-18, 2005, Dominique Gaïti, illustrated, Springer, 2007, ISBN 0387496890, 9780387496894.

In the prior art, Web servers widely use the RESUMPTION mode in order to limit the load of the asymmetric computations (RSA, etc). Typically, a browser, through an http request, downloads a first file (an HTML page) in FULL mode and then preserves the same MasterSecret (and therefore authorizes the RESUMPTION mode) for a predefined period of time, for example ten minutes.

The HTTP 1.1 (RFC 2616) standard recommends the use of two TCP connections at most between a Web browser and server. However, commercial browsers such as Internet Explorer use up to four simultaneous TCP connections.

The use of a single security module enables the downloading of at most 1/TF files per second in FULL mode and at most 1/TR files per second in RESUMPTION mode.

In the absence of any procedure for the transfer of the MasterSecret between security modules as proposed by an embodiment of the invention, the implementation of N security modules does not allow for exceeding the limit of N/TF files per second.

Indeed, since the security modules do not share data, they are obliged to initialize the secured sessions independently. Now, such an initialization must be done in FULL mode and not in RESUMPTION mode. Therefore, the maximum number of files transmitted per second cannot go beyond the limit of N/TF.

One of the advantageous characteristics of an embodiment of the invention is that it sets up the secured exchange of “MasterSecret” between security modules. In this case, the implementation of N security modules enables the downloading of at most N/TR files per second. Indeed, since the modules of the grid of security modules according to an embodiment of the invention share the MasterSecret (which it may be recalled is used to compose any other cryptographic or encipherment material subsequent to HANDSHAKE), the slave modules can be authorized to initiate a session in RESUMPTION mode.

Thus, if the number of TCP connections used by the browser is limited to NS, the optimum number of security modules N is equal to this value (N=NS). The file downloading limit is deduced from this by using the security grid architecture according to an embodiment of the invention: NS/TF.

### 5. Description of A Grid of Security Modules According To An Embodiment of the Invention

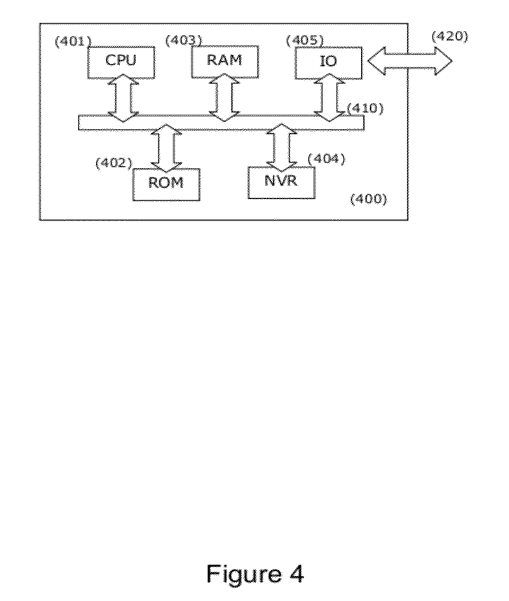

Referring to FIG. 4, we present a security module in the form of a silicon integrated circuit (400) usually called a “Tamper Resistant Device”, such as for example the component ST22 (produced by the firm ST Microelectronics) and available in different formats such as PVC boards (smart cards, SIM cards etc) integrated into USB sticks or MMC (Multimedia Card) memories.

A security module of this kind incorporates all the secured data storage means and also enables the execution of software in a secure and protected environment. More specifically, it comprises a central processing unit (CPU, 401), a ROM storing the code of the operating system (402), RAM (403), and a non-volatile memory (NVR, 404) used as a storage device that is similar to a hard disk drive and contains an embedded TLS software program. A system bus (410) links the different units of the secured module. The interface with the outside world (420) is provided by an input/output (I/O) port (405) compliant with standards such as ISO 7816, USB, USB-OTG, ISO 7816-12, MMC, IEEE 802.3, IEEE 802.11, etc.

JAVA type smart cards, commonly called JAVACARDS belong to a particular class of security module.

In at least one embodiment, a device implementing the method of an embodiment of the invention takes the form of a portable device such as a token or USB stick. This device comprises a storage means, especially a “security modules manager” type of software program according to the invention, and at least two readers of cards in the SIM format. The storage of the security modules manager according to the invention can be done on a specific electronic component of the FPGA (<<field-programmable gate array>> type.

Smart card readers can respectively receive master security modules and slave security modules to form a grid of security modules. When it is connected for example to a personal computer, the device acts as a security resources provider.

The Security Module Manager sets up an interface between the personal computer and the security modules. It is especially capable of transmitting commands for creating secret keys to the master module and commands for transmitting pre-calculated secret keys to the slave module.

Thus, in this embodiment, the invention makes it possible to provide in a very simple way a high-security solution without it being necessary to make many modifications in the existing communications architecture: at worst, it will be necessary to install a specific driver for the device on the computer on which the device has to be connected: this would be valid for example for computers having an older operating system. At best, the device according to an embodiment of the invention is recognized as being a standard smart card reader, requiring no additional installation.

In this embodiment and in all cases, the Security Module Manager component is responsible for being the interface between the grid of security modules and the terminal in which the device is plugged.

Although the present disclosure has been described with reference to one or more examples, workers skilled in the art will recognize that changes may be made in form and detail without departing from the scope of the disclosure and/or the appended claims.

1. A method for producing securing data for implementing a secured session between a first entity and at least one second entity, according to a protocol for setting up secured sessions, wherein the method comprises:
a step of initializing a third secured entity linked to said first entity;
a step of generating at least one part of said securing data within said third entity;
a first step of transmitting said securing data generated by said third secured entity towards said first entity;
a second step of transmitting at least one part of said securing data generated within said third secured entity intended for at least one fourth secured entity preliminarily initialized and linked to said third secured entity.

2. The method for producing securing data according to claim 1, wherein said third entity, called a master entity, generates at least one part of a secret shared between said first and said second entity.

3. The method for producing securing data according to claim 2, wherein said at least one part of said generated securing data transmitted to said at least one fourth entity, called a slave entity, includes said shared secret in an enciphered form and at least one secured communications session identifier.

4. The method of producing securing data according to claim 1, wherein said secured session set-up protocol is the SSL protocol.

5. The method of producing securing data according to claim 1, wherein said secured session set-up protocol is the TLS protocol.

6. The method for producing securing data according to claim 5, wherein the method further comprises:
a step of transmission, by said first entity, of at least one message to a functional “RECORD” unit implemented within said third entity;
a step of reception, by said first entity, of at least one message coming from said functional “RECORD” unit;
a step of computing of a set of keys by said third entity;
a step of collecting of said set of available keys by said first entity from said third entity.

7. The method for producing securing data according to claim 1, wherein said second step of transmission is implemented by a manager of security modules which obtains said securing data from said third entity.

8. The method for producing securing data according to claim 1, wherein said second transmission step is implemented during a phase for resuming said secured session.

9. A method for setting up a secured communications session between a first entity and at least one second entity, according to a protocol for setting up a secured session, wherein the method comprises:
a step of obtaining a session identifier and an ephemeral secret computed during a previous communications session secured by a third secured entity linked to said first entity;
a step of transmitting said session identifier and said ephemeral secret to a fourth secured entity preliminarily initialized and linked to said third secured entity;
a step of setting up a secured communications session by using said fourth secured entity.

10. A device for producing securing data, enabling the implementation of a secured session between a first entity and at least one second entity, according to a protocol for setting up secured sessions, wherein the device comprises:
means for initializing attached to said first entity;
means for generating at least one part of said securing data within said third entity;
means for transmitting said securing data to said first entity;
means for transmitting at least one part of said securing data generated within said third secured entity intended for at least one fourth secured entity preliminarily initialized and linked to said third secured entity.

11. The device for producing securing data according to claim 10, wherein said generating means and said transmitting means are grouped together in a smart card.

12. A portable device, comprising:
means for storing a manager of security modules;
at least two SIM-format card readers; and
a device for producing securing data, enabling implementation of a secured session between a first entity and at least one second entity, according to a protocol for setting up secured sessions, wherein the device comprises:
means for initializing attached to said first entity;
means for generating at least one part of said securing data within said third entity;
means for transmitting said securing data to said first entity; and
means for transmitting at least one part of said securing data generated within said third secured entity intended for at least one fourth secured entity preliminarily initialized and linked to said third secured entity.

13. A software product stored on a non-transitory computer-readable carrier and executable by a microprocessor, wherein the program comprises program code instructions for executing a method for producing securing data for implementing a secured session between a first entity and at least one second entity, according to a protocol for setting up secured sessions, when the instructions are executed on a computer, wherein the method comprises:
a step of initializing a third secured entity linked to said first entity;
a step of generating at least one part of said securing data within said third entity;
a first step of transmitting said securing data generated by said third secured entity towards said first entity;
a second step of transmitting at least one part of said securing data generated within said third secured entity intended for at least one fourth secured entity preliminarily initialized and linked to said third secured entity.

14. The method for producing according to claim 1, wherein said pieces of data transmitted to said at least one secured entity are implemented during a resumption of a secured communications session.
